(19) United States
(12) Patent Application Publication
(10) Pub. No.: US 2012/0291290 A1
(43) Pub. Date: Nov. 22, 2012

(54) Open Top Razor Cap and Dispenser

(76) Inventors: Michael Fishman, Coral Springs, FL (US); Neal Markus, Hollywood, FL (US)

(21) Appl. No.: 13/110,293

(22) Filed: May 18, 2011

(51) Int. Cl. B26B 21/44

(52) U.S. Cl. 30/41

(57) ABSTRACT

A disposable combination open top razor cap with razor head having an aerosol dispenser as the handle. The shaving cream can be dispensed by simply depressing the nozzle that is open on the cap and comes out through an extended dispenser opening. When the open top cap with the razor blade is attached the dispenser it is used as part of the handle. Also the razor cap does not need to be removed to spray out the shaving cream. Also the open top razor cap is removable so it could put on a full aerosol dispenser if the one it is on is empty. If the razor is worn it can be replaced with a newer open top razor on the dispenser. Additionally the razor itself can be replaced by itself on the open top razor cap.

### BACKGROUND

Traditional way of shaving involves the razor as a separate part than the dispenser. For the traveler it is not easy to carry a big bulky aerosol can and a shaver as two items. Additionally it is not allowed to carry a large size aerosol can on an airplane and passengers on airplanes are carrying less and less when they travel. The present invention makes it easier to carry a disposable shaver and shaving cream as one unit that is compact. There is no need to take the razor cap off in order to depress the shaving cream container which is a benefit of this invention.

### SUMMARY OF THE INVENTION

The invention is an Open Top Razor Cap and Dispenser which is a cap with a razor. In one embodiment of the invention the Cap is made to fit on to a standard mini aerosol can over the actuator or nozzle and the mounting cup on the aerosol can. In a preferred embodiment of the invention the nozzle is configured fit through the dispenser opening of the cap to help hold the cap onto the aerosol can. The nozzle also fits through the cap at the nozzle opening so it can be depressed to release shaving cream. In a preferred embodiment of the invention the dispenser unit is an aerosol containing shaving cream under pressure. The cap is removable from the dispenser so that if the razor is dull it can be replace by a newer one. The dispensing unit is removable so that if it contains no more shaving cream a new dispensing unit can be used with the razor. Also the razors are replaceable either by sliding the razor off by a grooved slide mechanism or by way of a prong type mechanism that can interchange the blade.

### OPERATION OF THE INVENTION

The operation of the Open Top Razor Cap is simply that when the Open Top Razor Cap is on the dispensing unit that the nozzle is pressed down which shaving cream then flows up preferable by aerosol technology in this embodiment of the invention. Because there is a Nozzle Opening in the Open Top Razor Cap the cap does not need to be removed and because there is a hole in the Open Top Razor Cap where the extended member of the nozzle goes through the Cap does not have to be removed for shaving cream to flow out.

### BRIEF DESCRIPTION OF THE DRAWINGS

FIG. 1000 shows a perspective view of just the open top razor cap to a preferred embodiment of the invention.

FIG. 2000 shows a perspective view of the removable open top razor cap on the dispensing unit to a preferred embodiment of the invention.

FIG. 3000 shows front side view of the dispensing unit of a preferred embodiment.

FIG. 4000 shows the open top razor cap and how it would be placed on the dispensing unit.

### DETAILED DESCRIPTION

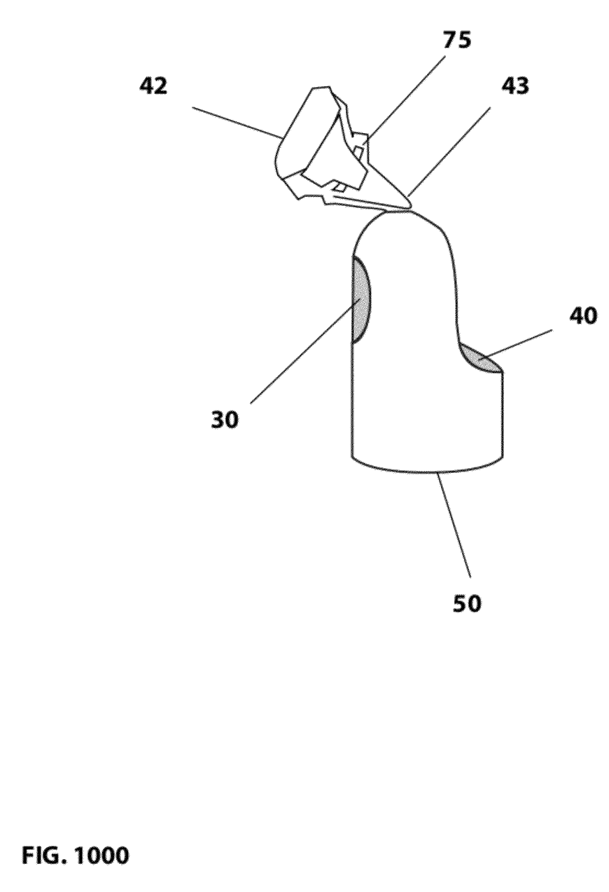

Referring now to FIG. 1000, a preferred embodiment of the invention is a Cap 50 configured so it can easily be attached and unattached from an aerosol dispenser in this preferred embodiment of the invention. The Cap 50 is specifically sized structured and configured for interlocking and removable for a pressurized dispensing unit. The Cap 50 has a nozzle opening 40. The Cap 50 also has a dispenser opening 30. The Cap 50 has a neck 43 that can be configured to be pivoting or not pivoting. The Neck 43 holds a razor 42 that is used for shaving. In this preferred embodiment of the invention the Cap 50 also has a Pivoting Member 75 which allows the razor to pivot to the contours of the shaving area.

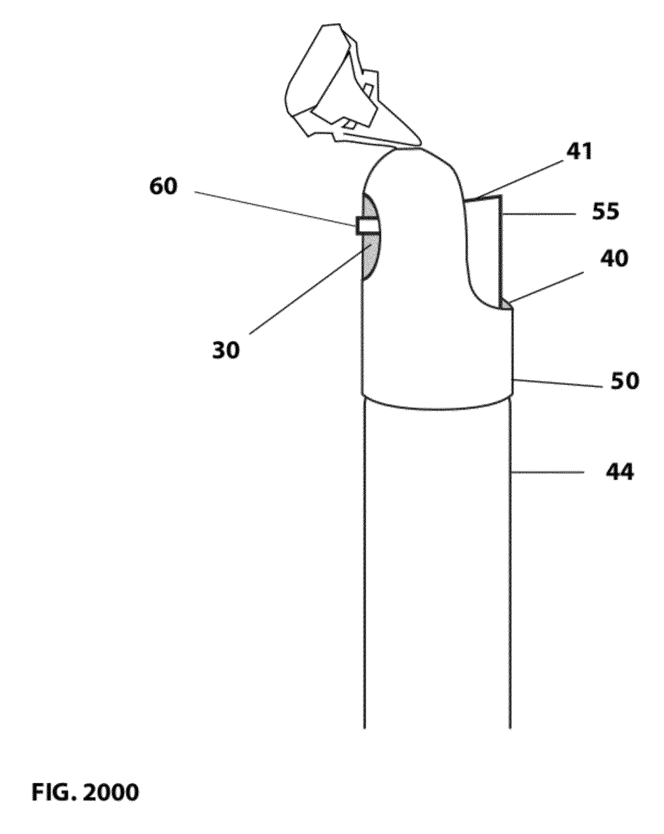

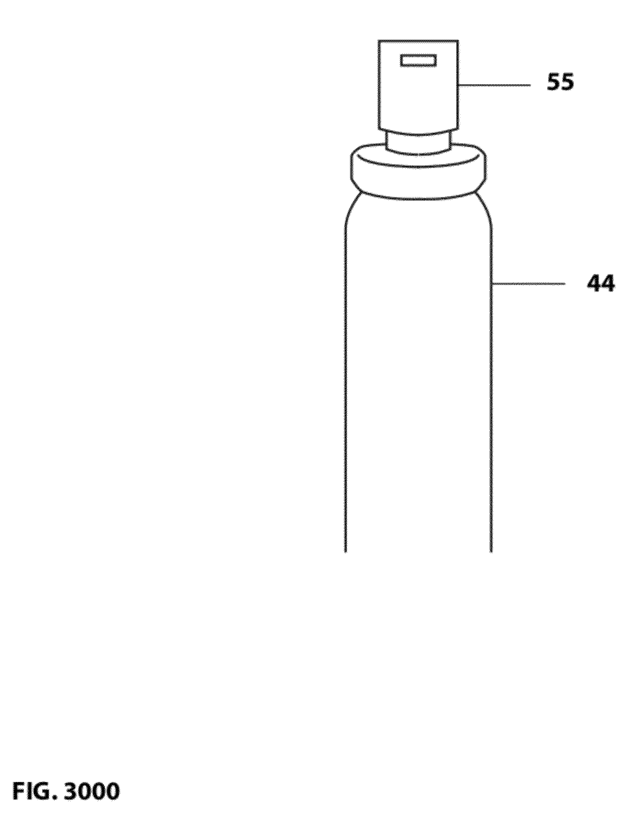

Referring now to FIG. 2000 a preferred embodiment of the invention shows the Cap 50 on a Dispensing Unit 44. In this preferred embodiment of the invention there Dispensing Unit 44 is an aerosol can. The Dispensing Unit 44 has a Nozzle 55 that is attached to the dispensing unit which is also know as an actuator if it is an aerosol. In this preferred embodiment of the invention the Nozzle 55 has a Grooved Top 41 for ease in pressing down and releasing the aerosol gas to push out the shaving cream foam the same way all shaving cream aerosols work. The shaving cream then will come through the Nozzle 55 and finally come out through an Extended Member 60 which will be extended beyond 30 the Dispenser Opening. In this preferred embodiment of the invention the extended member 60 fits through 30 Dispenser opening assisting the open cap razor top to stay on the dispenser and prevent the Cap 50 from easily slipping off.

Referring to 3000 in the preferred embodiment of the invention the Dispensing Unit 44 is shown by itself. In the preferred embodiment of the invention it is a aerosol can with the Nozzle 55 on top of it.

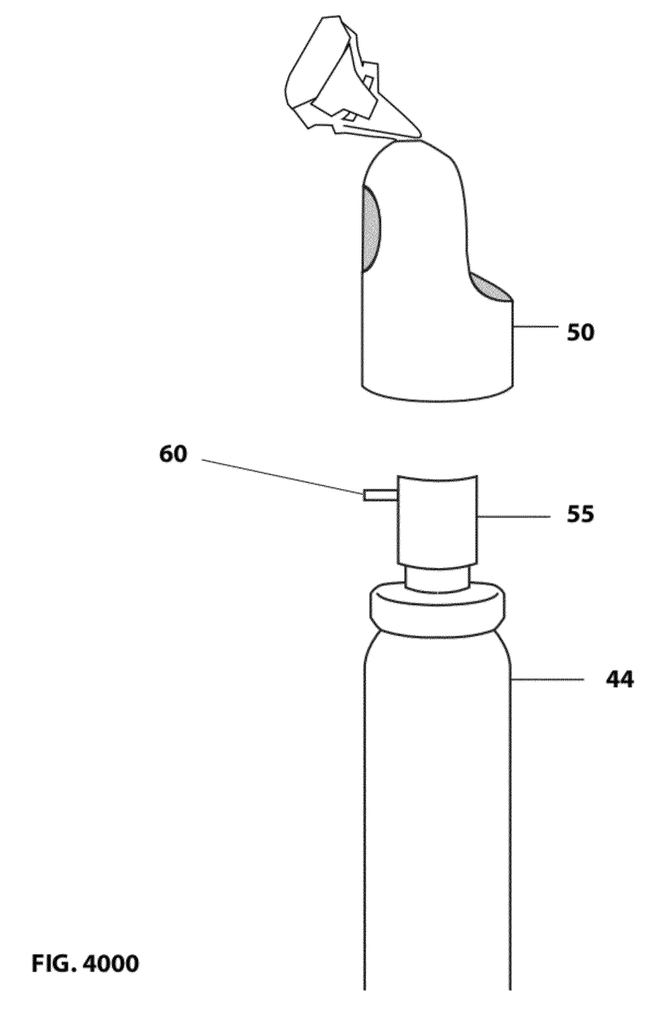

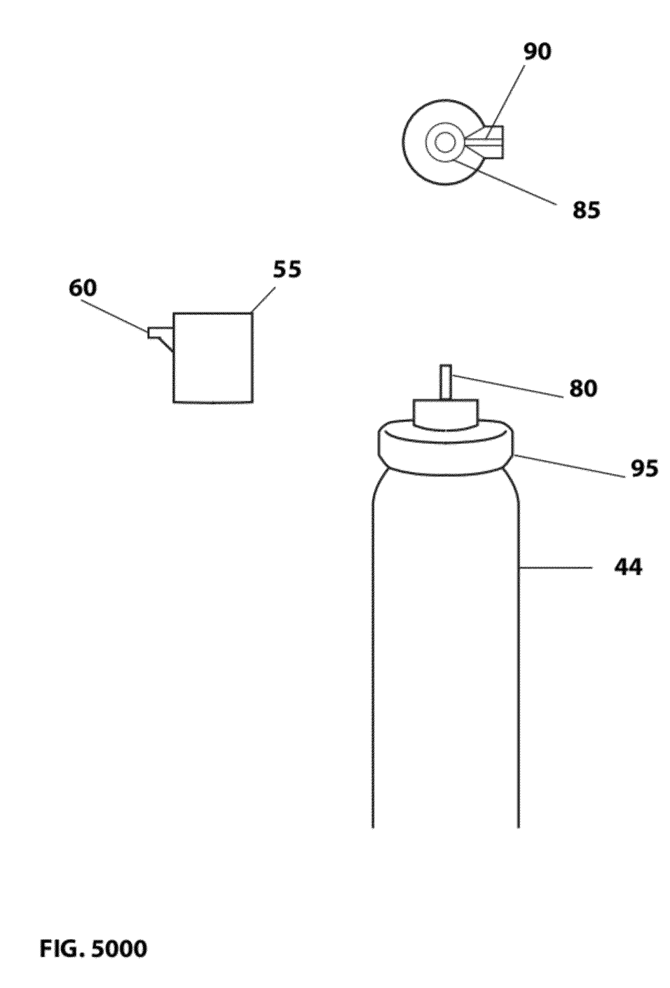

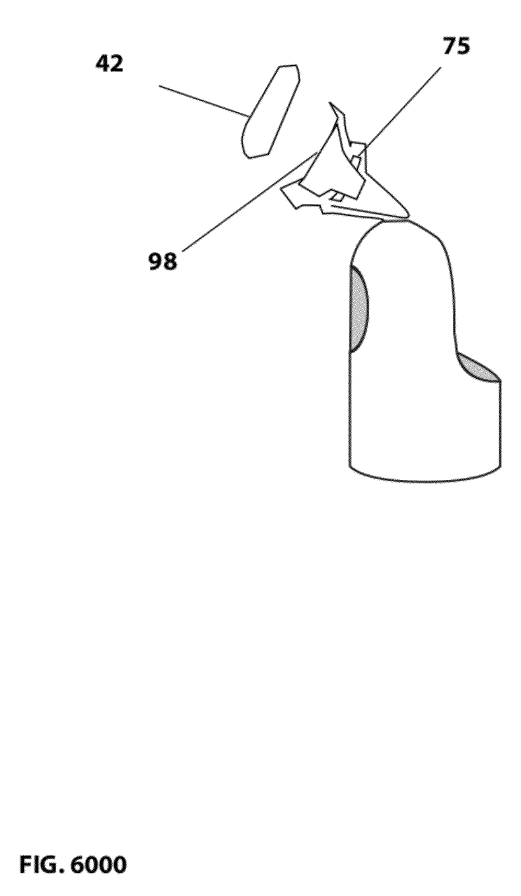

Referring to FIG. 4000 in the preferred embodiment of this invention. The Cap 50 is showed above the 44 Dispensing Unit. The Cap 50 is removable and can be put on and taken off of the Dispensing Unit 44 and the Nozzle 55. The Extended member 60 fits through the Cap 50.

Referring to FIG. 5000 a preferred embodiment of the invention the Dispensing Unit 44 has a Stem 80 to hold the nozzle in place. In this preferred embodiment of the invention Stem 80 is a male and the Nozzle 55 is the female. However in other embodiments of this invention it could be a female to male configuration. The Stem 80 is held in place by a Mounting Cup.95 which assist in keeping pressure in the 44 Dispensing Unit. The shaving cream will pass through a Nozzle Hole 85 and out a Nozzle Dispenser 90 and through the Extended Member 60.

Referring to FIG. 6000 of the Pivoting Member 75 will have an Attachment Member 98 that will assist in attaching a different Razor 42 to the Cap 50. In this embodiment of the invention the Razor 42 is attached by a snap mechanism however it could be done by a by a slide mechanism or a prong mechanism as well.

1. The invention is:
A. Open Top Razor Cap and Dispenser which comprises:
1. (a) A Cap that has a Razor.
1. an opening wherein the nozzle can be depressed causing shaving cream to be dispensed.
2. an opening wherein the shaving cream can be dispensed
(b) A Nozzle which operates with the dispenser that can dispense shaving cream
(c) A Dispenser that has a mounting cup that works with the nozzle to dispense shaving cream

2. The invention is:
A. Open Top Razor Cap and Dispenser which comprises:
1. (a) A Cap that has a Razor.
1. an opening wherein the nozzle can be depressed causing shaving cream to be dispensed.
2. an opening wherein the shaving cream can be dispensed
(b) A Nozzle which operates with the dispenser which extends through the Dispenser Opening of the Open Top Razor Cap keeping it on the dispenser
(c) A mounting cup that goes on the dispenser to hold the nozzle
(d) A Dispenser that is an aerosol

3. The invention is:
A. Open Top Razor Cap and Dispenser which comprises:
1. (a) A Cap
1. that has a Razor that is pivotable mounted
2. an opening wherein the nozzle can be depressed causing shaving cream to be dispensed.
3. an opening wherein the shaving cream can be dispensed
(b) A Nozzle that which operates with the dispenser
(c) A Dispenser to dispense shaving cream

4. The invention as recited in claim 2 is wherein the nozzle has a grooved top for ease of depressing it to dispense shaving cream

5. The invention as recited in claim 2 wherein the cap is cylindrical wherein it fits onto mini aerosol can.

6. The invention as recited in claim 2 is wherein the neck of the razor is not movable and is stationary

7. The invention as recited in claim 2 wherein the Open Top Razor Cap is made of plastic, acrylic or metal.

8. The invention as recited in claim 2 wherein the dispensing unit constitutes the handle portion

9. The invention as recited in claim 2 wherein the Open Top Razor cap can be easily taken off and put on another aerosol shaving cream

10. The invention as recited in claim 2 wherein the Open Top Razor Cap wherein the razor can be slid off by way of a grooved track and replaced with another razor.

11. The invention as recited in claim 2 wherein the razor can be taken off and on by way one or more prongs and be replaced.

12. The invention as recited in claim 2 has a nozzle that fits trough the Open Top Razor Cap helping to keep it on the can.
